(19) United States
(12) Patent Application Publication
(10) Pub. No.: US 2023/0367520 A1
(43) Pub. Date: Nov. 16, 2023

(54) IMAGE FORMING APPARATUS CAPABLE OF PREVENTING DELAY IN PROCESSING FOR DELIVERING OTHER PRINTED MATTER DUE TO ABSENCE OF USER WHO HAS INSTRUCTED DELIVERY OF PRINTED MATTER, CONTROL METHOD FOR IMAGE FORMING APPARATUS, STORAGE MEDIUM, AND PRINTED MATTER DELIVERY SYSTEM

(71) Applicant: CANON KABUSHIKI KAISHA, Tokyo (JP)

(72) Inventors: TSUTOMU KUBOTA, Chiba (JP); MANABU HADA, Tokyo (JP); MOTOKI KOSHIGAYA, Saitama (JP); TATSUYA OGAWA, Ibaraki (JP); TSUNAHITO NAKASHITA, Chiba (JP); HIDETAKA TABUCHI, Chiba (JP); AKITOMO FUKUI, Kanagawa (JP)

(21) Appl. No.: 18/299,743

(22) Filed: Apr. 13, 2023

(30) Foreign Application Priority Data
May 12, 2022 (JP) 2022-078915

(51) Int. Cl. G06F 3/12

(52) U.S. Cl. CPC G06F 3/1204; G06F 3/1288; G06F 3/1293; G06F 3/1237; G06F 3/1286

(57) ABSTRACT

An image forming apparatus capable of preventing a delay in a processing for delivering other printed matter due to the absence of a user is provided. The image forming apparatus that performs a print processing to produce a printed matter in accordance with an instruction from a user, and that transmits a delivery instruction that a delivery destination of the printed matter is set to a printed matter delivery apparatus, includes a controller that executes a presence confirmation processing for the user, and in a case that the presence of the user has been confirmed, transmits a delivery instruction that the user is set as the delivery destination to the printed matter delivery apparatus, and in a case that the presence of the user has not been confirmed, transmits a delivery instruction that a deputy for the user is set as the delivery destination to the printed matter delivery apparatus.

### BACKGROUND OF THE INVENTION

### Field of the Invention

The present invention relates to an image forming apparatus, a control method for the image forming apparatus, a storage medium, and a printed matter delivery system.

### Description of the Related Art

An image forming apparatus, which performs a print processing to produce a printed matter in accordance with a print instruction from a user, is known. The user is able to issue the print instruction with respect to the image forming apparatus from a computer. In the case that the user issues the print instruction with respect to the image forming apparatus from the computer, the user needs to go to the image forming apparatus to pick up the printed matter after issuing the print instruction, and this takes labor. In order to reduce such labor of the user, a printed matter delivery apparatus, which delivers the printed matter, has been developed. The printed matter delivery apparatus receives the printed matter, which is produced by the image forming apparatus, from the image forming apparatus, and delivers the received printed matter to the destination, for example, the seat of the user who has issued the print instruction (for example, see Japanese Laid-Open Patent Publication (kokai) No. 2016-179674).

Since the printed matter delivery apparatus moves at a relatively low speed, it takes a certain amount of time from when the user issues the print instruction until the printed matter is delivered to the seat of the user, and the user may leave the seat during this certain amount of time and the printed matter delivery apparatus may not be able to complete delivery of the printed matter. In such a case, for example, although it is assumed that the printed matter will be delivered to a deputy, it takes a lot of time from when the printed matter delivery apparatus starts moving to the deputy after moving to the seat of the user and confirming the absence of the user until the delivery of the printed matter has been completed, and during this lot of time, it is not possible to accept a processing for delivering other printed matter. That is, conventionally, there is a problem that the processing for delivering the other printed matter is delayed due to the absence of the user who has instructed the delivery of the printed matter.

### SUMMARY OF THE INVENTION

The present invention provides an image forming apparatus capable of preventing a delay in a processing for delivering other printed matter due to the absence of a user who has instructed delivery of a printed matter, a control method for the image forming apparatus, a storage medium, and a printed matter delivery system.

Accordingly, the present invention provides an image forming apparatus that performs a print processing to produce a printed matter in accordance with an instruction received from an information processing apparatus operated by a user, and that transmits a delivery instruction, in which a delivery destination of the printed matter is set, to a printed matter delivery apparatus, the image forming apparatus comprising a controller configured or programmed to execute a presence confirmation processing for confirming a presence status of the user, and in a case that the presence of the user has been confirmed, transmit a delivery instruction, in which the user is set as the delivery destination, to the printed matter delivery apparatus, and in a case that the presence of the user has not been confirmed, transmit a delivery instruction, in which a deputy for the user is set as the delivery destination, to the printed matter delivery apparatus.

According to the present invention, it is possible to prevent the delay in the processing for delivering the other printed matter due to the absence of the user who has instructed the delivery of the printed matter.

Further features of the present invention will become apparent from the following description of exemplary embodiments with reference to the attached drawings.

### BRIEF DESCRIPTION OF THE DRAWINGS

FIG. 1 is a diagram that shows an example of a network configuration of a printed matter delivery system, which includes an image forming apparatus according to a preferred embodiment of the present invention.

FIG. 2 is a diagram that shows an arrangement example of the image forming apparatus shown in FIG. 1.

FIG. 3 is a block diagram that schematically shows a hardware configuration of the image forming apparatus shown in FIG. 1.

FIG. 4 is an external view of the image forming apparatus shown in FIG. 1.

FIG. 5 is a block diagram that schematically shows a hardware configuration of an automatic delivery robot shown in FIG. 1.

FIG. 6 is an external view of the automatic delivery robot shown in FIG. 1.

FIG. 7 is a block diagram that schematically shows a hardware configuration of a storage box shown in FIG. 1.

FIG. 8 is an external view of the storage box shown in FIG. 1.

FIG. 9 is a diagram that shows an example of a setting screen displayed on a display unit of a personal computer (PC) shown in FIG. 2.

FIG. 10 is a diagram that shows a display example of the setting screen when a checkbox is checked.

FIGS. 11A and 11B are flow charts that show a procedure of a delivery control processing executed in the image forming apparatus shown in FIG. 1.

FIG. 12 is a diagram that shows an example of a presence confirmation screen displayed on the display unit of the PC shown in FIG. 2.

FIG. 13 is a diagram that shows an example of a reception propriety confirmation screen displayed on the display unit of the PC shown in FIG. 2.

FIG. 14 is a diagram that shows an example of a deputy reception completion screen displayed on the display unit of the PC shown in FIG. 2.

FIG. 15 is a diagram that shows an example of a storage completion screen displayed on the display unit of the PC shown in FIG. 2.

FIG. 16 is a flow chart that shows a procedure of a delivery processing executed by the automatic delivery robot shown in FIG. 1.

FIG. 17 is a flow chart that shows a procedure of a printed matter storage processing in the storage box shown in FIG. 1.

FIG. 18 is a flow chart that shows a procedure of an unlocking control processing in the storage box shown in FIG. 1.

FIGS. 19A and 19B are flow charts that show another procedure of the delivery control processing executed in the image forming apparatus shown in FIG. 1.

FIG. 20 is a diagram that shows an example of a presence confirmation screen displayed on a display unit of another PC shown in FIG. 2.

FIG. 21 is a diagram that shows an example of an authentication code screen displayed on the display unit of the another PC shown in FIG. 2.

### DESCRIPTION OF THE EMBODIMENTS

The present invention will now be described in detail below with reference to the accompanying drawings showing embodiments thereof.

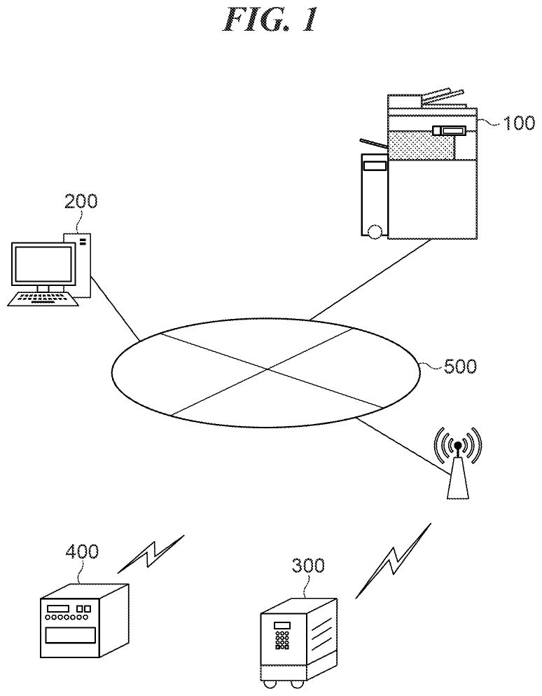

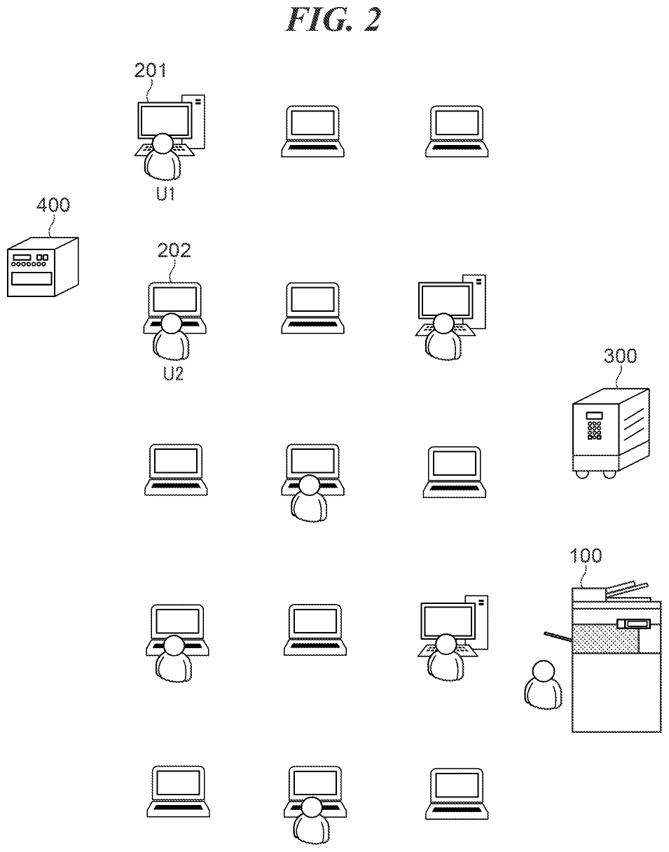

FIG. 1 is a diagram that shows an example of a network configuration of a printed matter delivery system, which includes an image forming apparatus 100 according to a preferred embodiment of the present invention. As shown in FIG. 1, the printed matter delivery system includes the image forming apparatus 100, a personal computer (PC) 200 functioning as an information processing apparatus, and an automatic delivery robot 300 functioning as a printed matter delivery apparatus. The image forming apparatus 100 is connected to a network 500. The PC 200 is also connected to the network 500. The image forming apparatus 100 is able to communicate with the PC 200 via the network 500. It should be noted that as an example, although FIG. 1 shows a configuration in which one PC 200 is connected to the network 500, in the preferred embodiment of the present invention, as shown in FIG. 2, it is assumed to be used in an office, and a plurality of PCs are connected to the network 500. Furthermore, an access point AP is also connected to the network 500. The image forming apparatus 100 is able to communicate with device(s) connected to a wireless local area network (a wireless LAN) via the access point AP. For example, the image forming apparatus 100 is able to communicate with the automatic delivery robot 300 having a wireless LAN function and a storage box 400 having a wireless LAN function.

FIG. 2 is a diagram that shows an arrangement example of the image forming apparatus 100 shown in FIG. 1. In FIG. 2, one image forming apparatus 100, one automatic delivery robot 300, and one storage box 400 are arranged. Furthermore, in FIG. 2, a different PC is assigned to each user, and for example, a user U1 uses a PC 201 with the same functions and the same configuration as the PC 200, and a user U2 uses a PC 202 with the same functions and the same configuration as the PC 200. All PCs shown in FIG. 2 are connected to the image forming apparatus 100 via the network 500. In addition, the image forming apparatus 100 is connected to the automatic delivery robot 300 and the storage box 400 via the wireless LAN.

Next, the configuration of the image forming apparatus 100 will be described. The image forming apparatus 100 is a multifunction peripheral (an MFP) that includes multiple functions such as a print function, a scanner function, a copy function, and a FAX function. The image forming apparatus 100 performs a print processing based on an instruction received from the PC 200 to produce a printed matter, and delivers the printed matter to the automatic delivery robot 300. Further, the image forming apparatus 100 transmits information regarding a delivery destination of the printed matter, authentication information used when receiving the printed matter, etc. to the automatic delivery robot 300. Furthermore, the image forming apparatus 100 obtains a delivery status of the printed matter from the storage box 400.

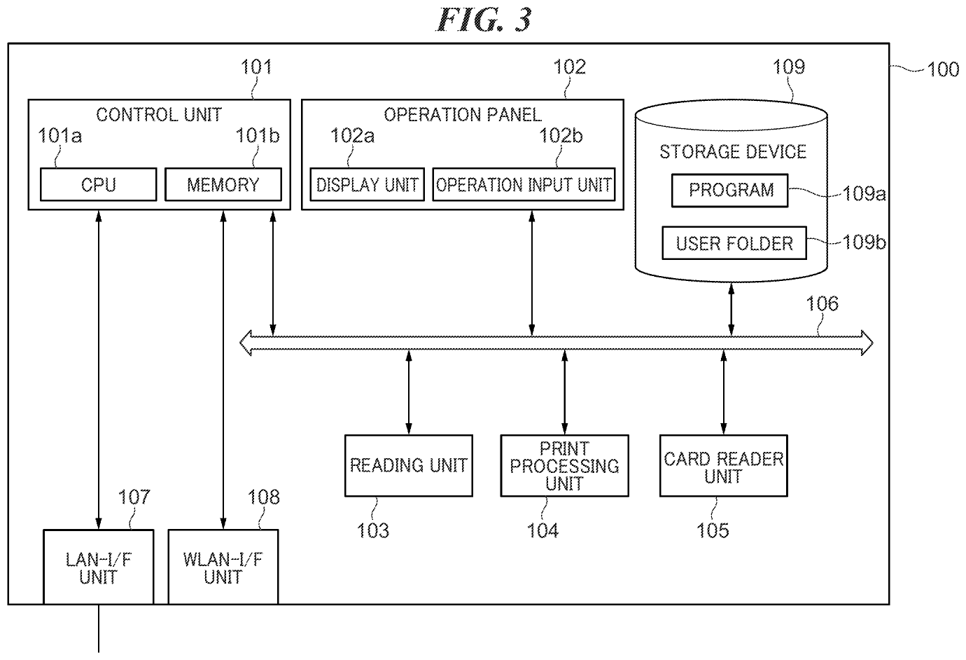

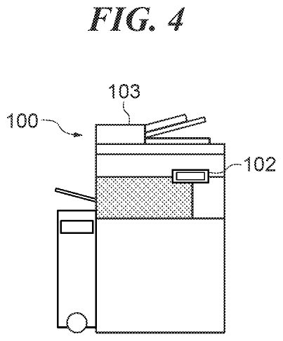

FIG. 3 is a block diagram that schematically shows a hardware configuration of the image forming apparatus 100 shown in FIG. 1. FIG. 4 is an external view of the image forming apparatus 100 shown in FIG. 1.

As shown in FIG. 3, the image forming apparatus 100 includes a control unit 101, an operation panel 102, a reading unit 103, a print processing unit 104, a card reader unit 105, a local area network interface unit (a LAN-I/F unit) 107, a wireless local area network interface unit (a WLAN-I/F unit) 108, and a storage device 109. The control unit 101, the operation panel 102, the reading unit 103, the print processing unit 104, the card reader unit 105, and the storage device 109 are connected to each other via a bus 106.

The control unit 101, which functions as a controller, controls the operation of the image forming apparatus 100. The control unit 101 includes a central processing unit (a CPU) 101a and a memory 101b. The CPU 101a reads out a program 109a stored in the storage device 109 and executes it. The memory 101b stores temporary data, etc. that are generated by the CPU 101a executing the program 109a.

The operation panel 102 is a user interface and accepts operation instructions from the user. The operation panel 102 is configured by a liquid crystal panel or the like. The operation panel 102 includes a display unit 102a that displays various kinds of information, and an operation input unit 102b that accepts an operation instruction from the user by detecting an operation with respect to the display unit 102a.

The reading unit 103 reads image(s) of document(s) and generates image data. The print processing unit 104 performs the print processing based on the image data generated by the reading unit 103 to produce the printed matter. The card reader unit 105 reads a card for performing personal authentication of the user. Furthermore, the LAN-I/F unit 107 is an interface for connecting to a wired network and communicating with external apparatus(es). The WLAN-I/F unit 108 is an interface for connecting to a wireless network and communicating with the external apparatus(es). The storage device 109 stores the program 109a, the image data, setting information, etc. In addition, the storage device 109 includes a user folder 109b for storing print data used for the print processing.

Next, the configuration of the automatic delivery robot 300 will be described. The automatic delivery robot 300 receives the printed matter from the image forming apparatus 100, stores the printed matter in a collecting unit 306 described below, and delivers the printed matter to the delivery destination designated by the image forming apparatus 100.

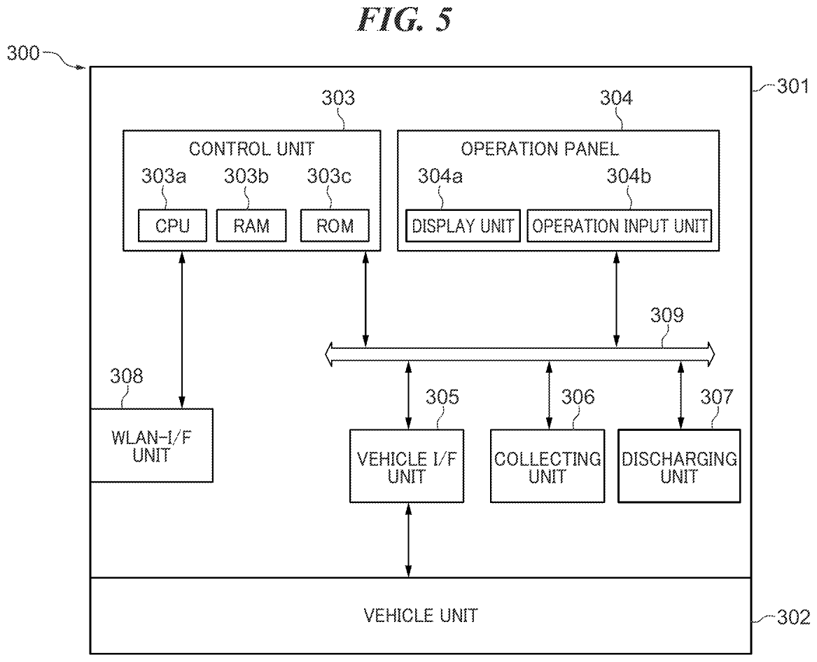

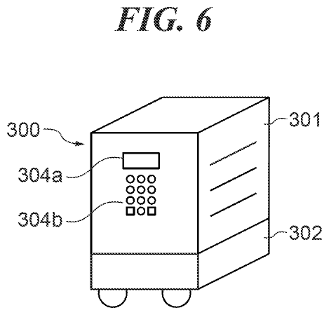

FIG. 5 is a block diagram that schematically shows a hardware configuration of the automatic delivery robot 300 shown in FIG. 1. FIG. 6 is an external view of the automatic delivery robot 300 shown in FIG. 1.

As shown in FIG. 5, the automatic delivery robot 300 includes a delivery robot control unit 301 that controls the operation of the automatic delivery robot 300, and a vehicle unit 302 for moving to a designated location based on pre-stored map information.

The delivery robot control unit 301 includes a control unit 303, an operation panel 304, a vehicle I/F unit 305, the collecting unit 306, and a discharging unit 307. The control unit 303, the operation panel 304, the vehicle I/F unit 305, the collecting unit 306, and the discharging unit 307 are connected to each other via a bus 309. Furthermore, the delivery robot control unit 301 includes a WLAN-I/F unit 308 for connecting to the wireless network and communicating with the external apparatus(es).

The control unit 303 controls the operation of the delivery robot control unit 301. The control unit 303 includes a CPU 303a, a random access memory (a RAM) 303b, and a read only memory (a ROM) 303c. The CPU 303a reads out a program stored in the ROM 303c and executes it. The RAM 303b stores temporary data, etc. that are generated by the CPU 303a executing the program. The ROM 303c stores an operation program, etc. of the delivery robot control unit 301.

The operation panel 304 is a user interface and accepts operation instructions from the user. The operation panel 304 is configured by a liquid crystal panel or the like. The operation panel 304 includes a display unit 304a that displays various kinds of information, and an operation input unit 304b that accepts an operation instruction from the user by detecting an operation with respect to the display unit 304a.

The vehicle I/F unit 305 is an interface for communicating with the vehicle unit 302. The collecting unit 306 includes a locking function and stores the printed matter received from the image forming apparatus 100. The discharging unit 307 discharges the printed matter, which has been stored in the collecting unit 306, to the outside. In the preferred embodiment of the present invention, in the case that an authentication code corresponding to the printed matter, which has been stored in the collecting unit 306, is inputted into the operation panel 304, the user is able to take the printed matter out from the collecting unit 306.

Next, the configuration of the storage box 400 will be described. The storage box 400, which functions as a storage apparatus, is for safely storing the printed matter, and includes a locking function. The storage box 400 is locked when the printed matter is stored, and it is necessary to input an authentication code when taking out the stored printed matter.

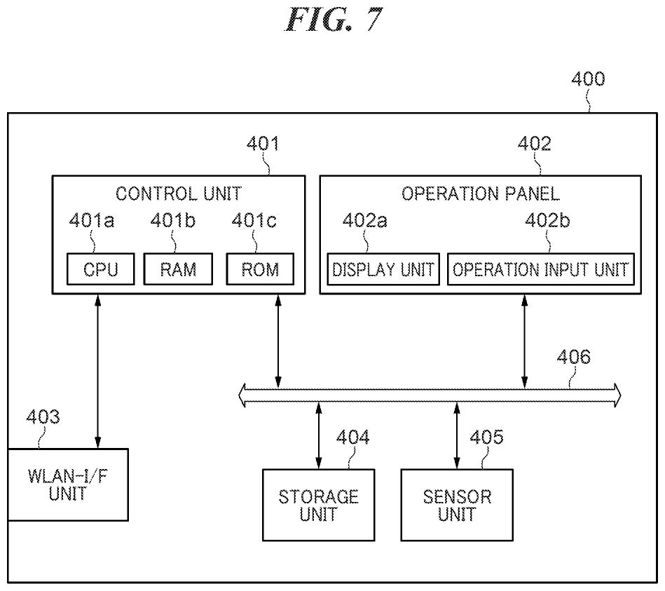

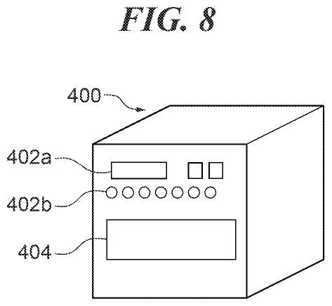

FIG. 7 is a block diagram that schematically shows a hardware configuration of the storage box 400 shown in FIG. 1. FIG. 8 is an external view of the storage box 400 shown in FIG. 1. As shown in FIG. 7, the storage box 400 includes a control unit 401, an operation panel 402, a storage unit 404, and a sensor unit 405. The control unit 401, the operation panel 402, the storage unit 404, and the sensor unit 405 are connected to each other via a bus 406. Furthermore, the storage box 400 includes a WLAN-I/F unit 403 for connecting to the wireless network and communicating with the external apparatus(es).

The control unit 401 controls the operation of the storage box 400. The control unit 401 includes a CPU 401a, a RAM 401b, and a ROM 401c. The CPU 401a reads out a program stored in the ROM 401c and executes it. The RAM 401b stores temporary data, etc. that are generated by the CPU 401a executing the program. The ROM 401c stores an operation program, etc. of the storage box 400.

The operation panel 402 is a user interface and accepts operation instructions from the user. The operation panel 402 is configured by a liquid crystal panel or the like. The operation panel 402 includes a display unit 402a that displays various kinds of information, and an operation input unit 402b that accepts an operation instruction from the user by detecting an operation with respect to the display unit 402a. The storage unit 404 stores the printed matter and has the locking function. The sensor unit 405 detects whether or not the printed matter has been stored in the storage unit 404.

Next, a request for a print delivery processing, which is made with respect to the image forming apparatus 100 by the user using the PC, will be described.

In the print delivery processing, the image forming apparatus 100 performs the print processing based on the print data received from the PC to produce the printed matter, and the automatic delivery robot 300 delivers the printed matter to the designated delivery destination, for example, the request source of the print delivery processing. Here, as an example, a case of requesting a print delivery processing, which produces a printed matter of document(s) created by the user U1 and delivers the printed matter produced to a seat of the user U1, from the PC 201 to the image forming apparatus 100 will be described.

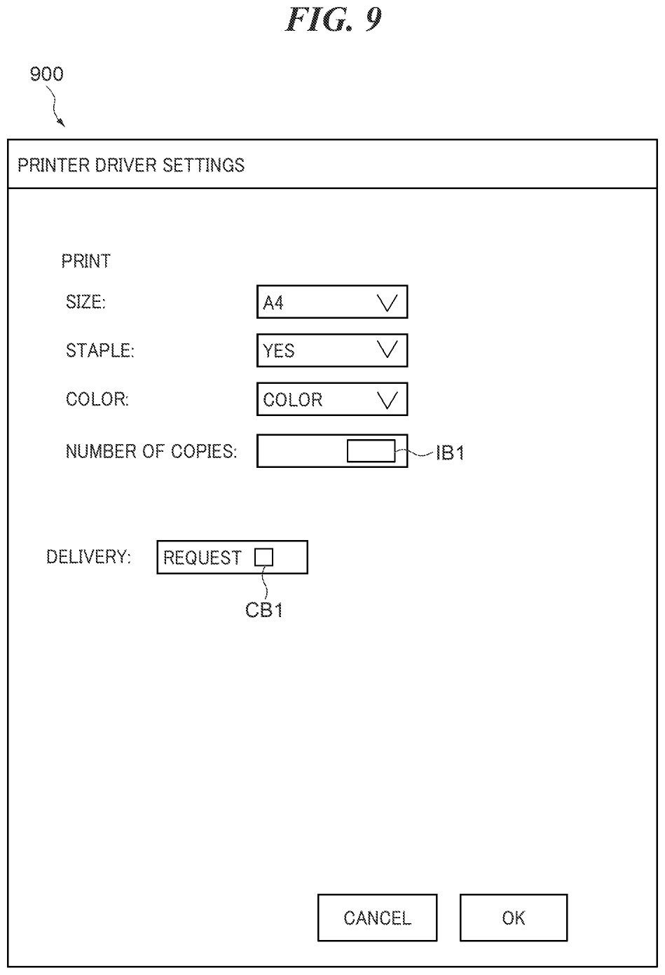

The user U1 activates a printer driver (not shown) for the image forming apparatus 100 on the PC 201, which also functions as an accepting unit that accepts an instruction for executing the print delivery processing, and performs settings of the print delivery processing. FIG. 9 is a diagram that shows an example of a setting screen 900 displayed on a display unit of the PC 201 shown in FIG. 2. The setting screen 900 is displayed on the display unit of the PC 201 when the printer driver for the image forming apparatus 100 is activated on the PC 201. The setting screen 900 is a screen for issuing the instruction for executing the print delivery processing. In a print category of the setting screen 900, setting values related to printing such as sheet size, yes/no of stapling, and color/black-and-white setting are set. In addition, in the print category of the setting screen 900, the number of copies to be printed is set.

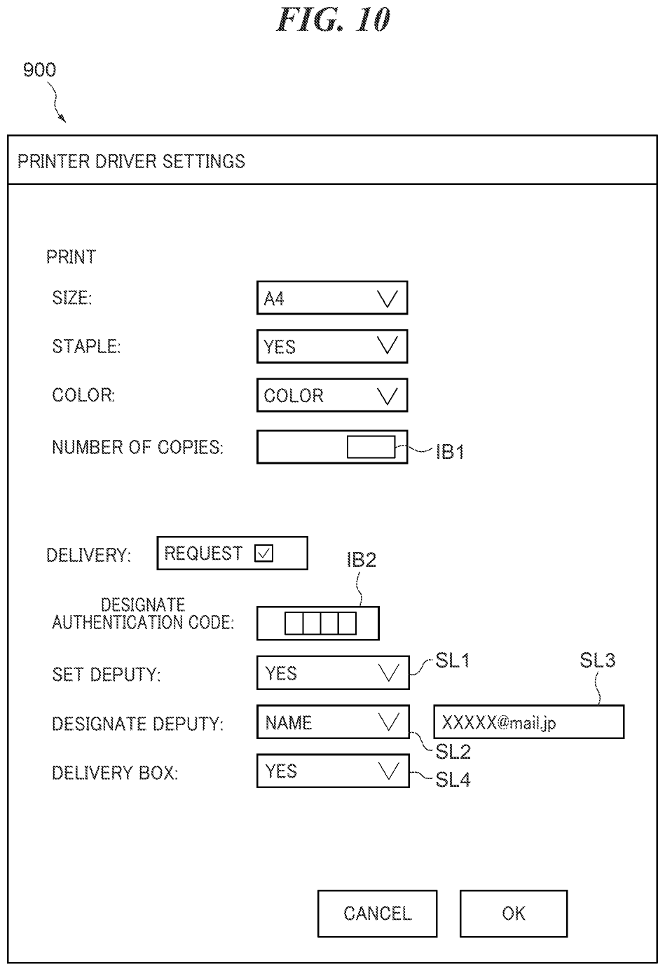

In the case of requesting the delivery of the printed matter performed by the automatic delivery robot 300, the user U1 checks a check box CB1 of a delivery category of the setting screen 900. When the check box CB1 is checked, as shown in FIG. 10, in the delivery category, setting items related to delivery are additionally displayed. The user U1 inputs the authentication code required when receiving the printed matter into an input field IB2. In the case that the user U1 can certainly receive the delivered printed matter, it is possible to request the delivery of the printed matter only by setting the authentication code. In addition, in the preferred embodiment of the present invention, the user U1 is also able to designate a receiving deputy who receives the delivered printed matter instead of the user U1. Specifically, the user U1 selects “yes” from a pull-down menu SL1 for deputy setting in the delivery category. In addition, the user U1 selects the name of the receiving deputy from a pull-down menu SL2 for deputy designation in the delivery category. It should be noted that preset names are displayed on the pull-down menu SL2 for deputy designation. When the name of the receiving deputy is selected in the pull-down menu SL2 for deputy designation, an e-mail address of the selected receiving deputy is displayed on a display field SL3. The PC 201 also functions as a setting unit that sets a deputy for the user U1 (the receiving deputy) who receives the printed matter instead of the user U1.

In addition, in the preferred embodiment of the present invention, in the case that there is a possibility that the receiving deputy is also absent, it is also possible to use the storage box 400. When “yes” is selected from a pull-down menu SL4 for delivery box in the delivery category, in the case that neither the user U1 nor the receiving deputy is present, the printed matter is stored in the storage box 400. In addition, the image forming apparatus 100 notifies the PC 201 of the user U1 of a communication that indicates the location of the storage box 400, etc. It should be noted that in the preferred embodiment of the present invention, as an example, although a configuration, in which the setting value for deputy setting, the setting value for deputy designation, and the setting value for delivery box are selected from the pull-down menus, has been described, a configuration, in which the user directly inputs the setting value for deputy setting, the setting value for deputy designation, and the setting value for delivery box, may be used.

When the user U1 completes the settings of the setting screen 900 and selects an OK button, the PC 201 generates the print data for executing the print delivery processing based on the setting values set on the setting screen 900, and transmits the generated print data to the image forming apparatus 100. In this way, the request for the print delivery processing is made.

In addition, after transmitting the print data to the image forming apparatus 100, the printer driver of the PC 201 periodically performs polling with respect to the image forming apparatus 100. The image forming apparatus 100 utilizes the polling performed by the printer driver of the PC 201 to perform, for example, a presence confirmation processing for the user which will be described below, and a reception propriety confirmation processing for the user which will be described below.

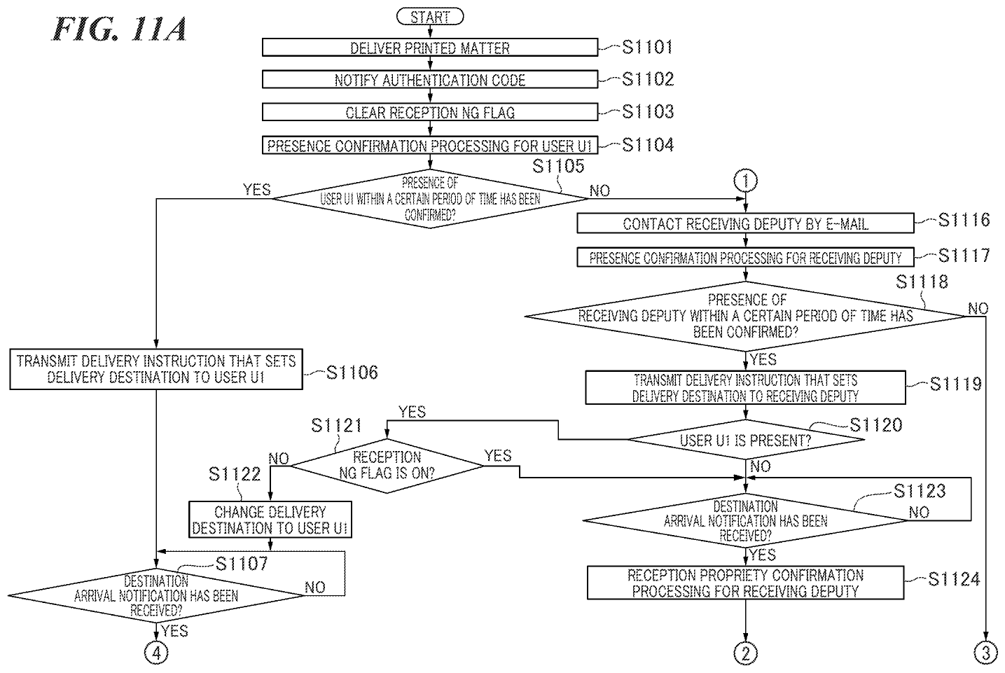

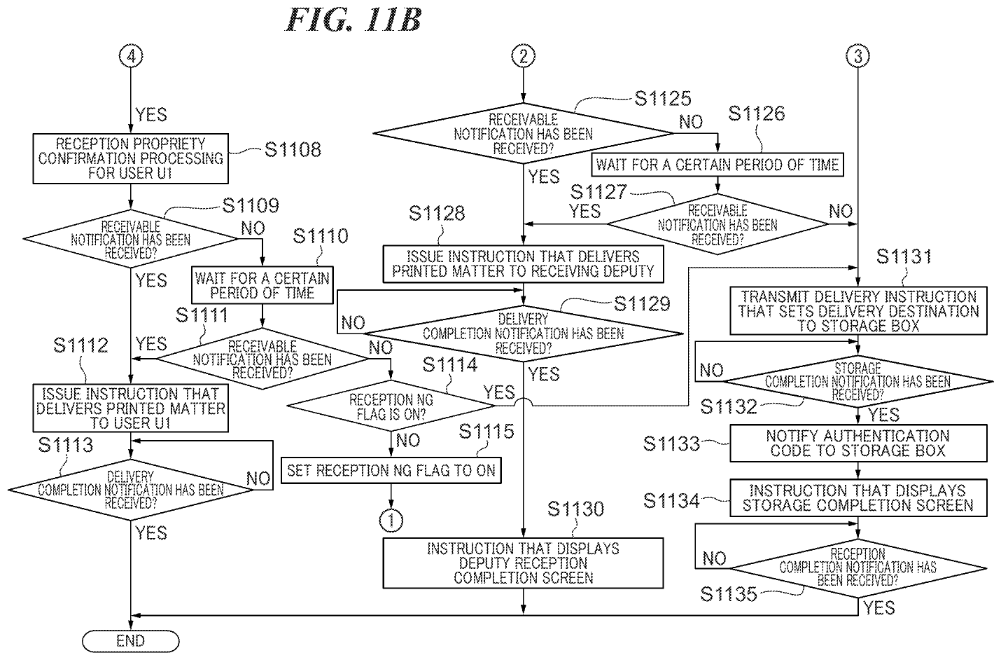

The CPU 101a of the image forming apparatus 100 that has received the print data, which is the request for the print delivery processing, from the PC 201 temporarily stores the received print data in the user folder 109b of the storage device 109. Thereafter, the CPU 101a reads the print data stored in the user folder 109b into the memory 101b, converts the print data into image data, and outputs the image data to the print processing unit 104. The print processing unit 104 prints the received image data on printing sheet. When the production of all printed matters related to the received print data is completed, the CPU 101a communicates with the automatic delivery robot 300 via the WLAN-I/F unit 108 and executes a delivery control processing shown in FIGS. 11A and 11B.

FIGS. 11A and 11B are flow charts that show a procedure of the delivery control processing executed in the image forming apparatus 100 shown in FIG. 1. The delivery control processing shown in FIGS. 11A and 11B is realized by the CPU 101a reading the program 109a stored in the storage device 109 into the memory 101b and executing it. The delivery control processing shown in FIGS. 11A and 11B is executed when the production of all printed matters related to the received print data is completed. In FIGS. 11A and 11B, as an example, it is assumed that the delivery control processing is a processing based on a request received from the user U1.

As shown in FIGS. 11A and 11B, the CPU 101a delivers the produced printed matter to the automatic delivery robot 300 (a step S1101). Next, the CPU 101a controls the WLAN-I/F unit 108 to notify the automatic delivery robot 300 of an authentication code (code information) (a step S1102). This authentication code is the authentication code inputted into the input field IB2 of the setting screen 900 when the request for the print delivery processing is made. Next, the CPU 101a clears a reception NG flag (a step S1103). Specifically, the CPU 101a sets a reception NG flag bit within the memory 101b to “0”. It should be noted that the reception NG flag is history information that records (indicates) that the delivery of the printed matter has not been completed even though the automatic delivery robot 300 has delivered the printed matter to the seat of the user U1 who is the request source of the print delivery processing.

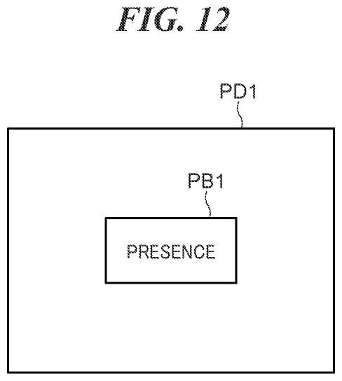

Next, the CPU 101a, which also functions as a processing unit that executes the presence confirmation processing for confirming a presence status of the user U1 who has issued the instruction for executing the print delivery processing, performs the presence confirmation processing for confirming the presence status of the user U1 (a step S1104). Specifically, the CPU 101a transmits an instruction that displays a presence confirmation screen to the PC 201 of the user U1. The PC 201 that has received the instruction that displays the presence confirmation screen causes the display unit of the PC 201 to display, for example, a presence confirmation screen PD1 shown in FIG. 12. The presence confirmation screen PD1 is a pop-up screen. A presence button PB1 is displayed on the presence confirmation screen PD1 so as to be blinking. When the user U1 selects the presence button PB1, the PC 201 transmits a presence confirmation notification, which indicates that the user U1 is present, to the image forming apparatus 100. Moreover, as described above, the presence confirmation processing for the user U1 in the step S1104 is performed by utilizing the polling performed by the printer driver of the PC 201.

Next, the CPU 101a judges whether or not the presence of the user U1 within a certain period of time has been confirmed (a step S1105). In the step S1105, for example, in the case that the presence confirmation notification has been received from the image forming apparatus 100 before a predetermined period of time set in advance elapses after the production of the printed matter is completed, the CPU 101a judges that the presence of the user U1 within the certain period of time has been confirmed. On the other hand, in the step S1105, in the case that the presence confirmation notification has not been received from the image forming apparatus 100 before the predetermined period of time elapses after the production of the printed matter is completed, the CPU 101a judges that the presence of the user U1 within the certain period of time has not been confirmed. In the case of being judged in the step S1105 that the presence of the user U1 within the certain period of time has been confirmed, the delivery control processing proceeds to a step S1106. The CPU 101a also functions as a delivery destination setting unit that sets the user U1 to the delivery destination of the printed matter in the case that the presence of the user U1 has been confirmed, and sets the deputy for the user U1 to the delivery destination of the printed matter in the case that the presence of the user U1 has not been confirmed.

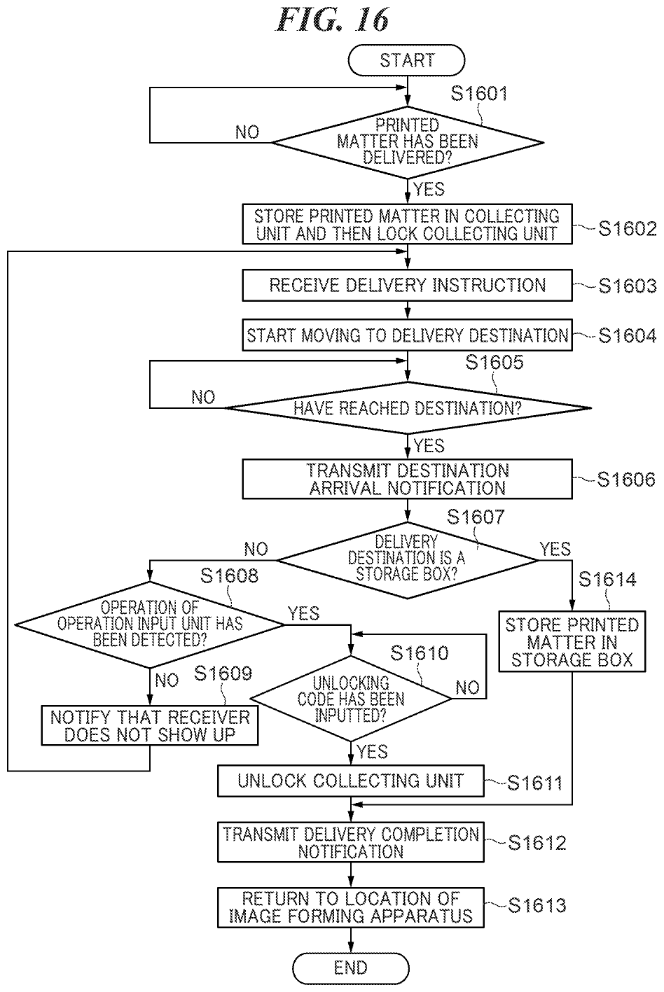

In the step S1106, the CPU 101a transmits a delivery instruction, in which the user U1 is set as the delivery destination, to the automatic delivery robot 300. The delivery instruction, in which the user U1 is set as the delivery destination, includes delivery destination information such as information indicating the user U1 set as the delivery destination, information indicating the position of the seat of the user U1, etc. In addition, the delivery instruction, in which the user U1 is set as the delivery destination, also includes the authentication code required when receiving the printed matter. The automatic delivery robot 300 that has received the delivery instruction, in which the user U1 is set as the delivery destination, performs a delivery processing shown in FIG. 16, which will be described below. When the automatic delivery robot 300 arrives at the set delivery destination, the automatic delivery robot 300 transmits a destination arrival notification to the image forming apparatus 100.

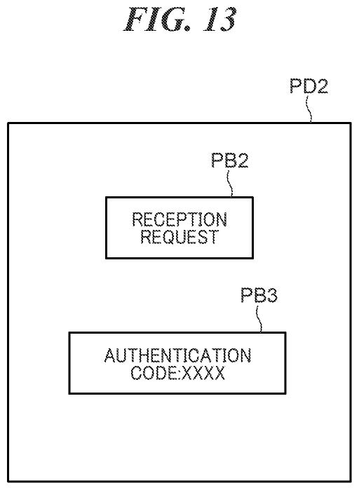

The CPU 101a waits until it receives the destination arrival notification from the automatic delivery robot 300. When the CPU 101a receives the destination arrival notification from the automatic delivery robot 300 (YES in a step S1107), the CPU 101a performs the reception propriety confirmation processing that confirms whether or not the user U1 is able to receive the printed matter (a step S1108). Specifically, the CPU 101a transmits an instruction that displays a reception propriety confirmation screen to the PC 201. The PC 201 that has received the instruction that displays the reception propriety confirmation screen causes the display unit of the PC 201 to display, for example, a reception propriety confirmation screen PD2 shown in FIG. 13. The reception propriety confirmation screen PD2 is also a pop-up screen. A button PB2 for confirming whether or not the user U1 is able to receive the printed matter, and an authentication code PB3, which is required when receiving the printed matter, are displayed on the reception propriety confirmation screen PD2. The user U1 selects the button PB2 in the case that the user U1 is able to receive the printed matter, and does not select the button PB2 in the case that the user U1 is not able to receive the printed matter. When the user U1 selects the button PB2, the PC 201 transmits a receivable notification, which indicates that the user U1 is able to receive the printed matter, to the image forming apparatus 100. Moreover, the reception propriety confirmation processing for the user U1 in the step S1108 is also performed by utilizing the polling performed by the printer driver of the PC 201.

The CPU 101a judges whether or not the receivable notification has been received from the PC 201 (a step S1109). In the case of being judged in the step S1109 that the receivable notification has been received from the PC 201, the delivery control processing proceeds to a step S1112 described below. In the case of being judged in the step S1109 that the receivable notification has not been received from the PC 201, the CPU 101a waits for a certain period of time determined in advance (a step S1110). Next, the CPU 101a judges whether or not the receivable notification has been received from the PC 201 (a step S1111). In the case of being judged in the step S1111 that the receivable notification has been received from the PC 201, the delivery control processing proceeds to the step S1112.

In the step S1112, the CPU 101a issues an instruction, which delivers the printed matter to the user U1, with respect to the automatic delivery robot 300. Next, the CPU 101a waits until it receives a delivery completion notification, which indicates that the delivery of the printed matter has been completed, from the automatic delivery robot 300. When the CPU 101a receives the delivery completion notification from the automatic delivery robot 300 (YES in a step S1113), the delivery control processing ends.

In the case of being judged in the step S1111 that the receivable notification has not been received from the PC 201, the CPU 101a judges whether or not the reception NG flag is ON (a step S1114). In the preferred embodiment of the present invention, in the case that the delivery of the printed matter has not been completed even though the automatic delivery robot 300 has delivered the printed matter to the seat of the user U1 who is the request source of the print delivery processing, the reception NG flag bit in the memory 101b is set to “1”. In the step S1114, in the case that the reception NG flag bit in the memory 101b is set to “1”, the CPU 101a judges that the reception NG flag is ON. On the other hand, in the case that the reception NG flag bit in the memory 101b is set to, for example, “0” instead of “1”, the CPU 101a judges that the reception NG flag is not ON.

In the step S1114, in the case that the reception NG flag is not ON, the CPU 101a sets the reception NG flag to ON (a step S1115). Specifically, the CPU 101a sets the reception NG flag bit in the memory 101b to “1”. Next, the delivery control processing proceeds to a step S1116 described below.

In the case of being judged in the step S1105 that the presence of the user U1 within the certain period of time has not been confirmed, the CPU 101a contacts the receiving deputy designated by the user U1, for example, the user U2 by e-mail, that is, the CPU 101a sends an e-mail to the PC of the receiving deputy designated by the user U1, for example, the PC 202 of the user U2 (the step S1116). The e-mail includes a notification indicating that the user U2 has been designated as the receiving deputy of the printed matter, and the authentication code required when receiving the printed matter. When the user U2 clicks link information described in the e-mail, a printer driver of the PC 202 is activated, and a communication between the printer driver of the PC 202 and the image forming apparatus 100 performed by the polling is started. Next, the CPU 101a performs the presence confirmation processing for the user U2 who is the receiving deputy by a method similar to the step S1104 described above (a step S1117). When the user U2 selects the presence button PB1 of the presence confirmation screen PD1 displayed on a display unit of the PC 202, the PC 202 transmits a presence confirmation notification, which indicates that the user U2 is present, to the image forming apparatus 100. As described above, in the preferred embodiment of the present invention, in the case that the presence of the user U1 who is the request source of the print delivery processing has not been confirmed, the presence confirmation processing for the user U2 who is the receiving deputy is executed. As a result, it is possible to prevent an unnecessary presence confirmation screen PD1 from being displayed on the display unit of the PC 202 of the user U2 who is the receiving deputy even though the user U1 who is the request source of the print delivery processing is present.

Next, by a method similar to the step S1105, the CPU 101a judges whether or not the presence of the user U2 within a certain period of time has been confirmed (a step S1118). In the case of being judged in the step S1118 that the presence of the user U2 within the certain period of time has been confirmed, the delivery control processing proceeds to a step S1119.

In the step S1119, the CPU 101a transmits a delivery instruction, in which the user U2 who is the receiving deputy is set as the delivery destination, to the automatic delivery robot 300. The delivery instruction, in which the user U2 who is the receiving deputy is set as the delivery destination, includes delivery destination information such as information indicating the user U2 set as the delivery destination, information indicating the position of a seat of the user U2, etc. In addition, the delivery instruction, in which the user U2 who is the receiving deputy is set as the delivery destination, also includes the authentication code required when receiving the printed matter. The automatic delivery robot 300 that has received the delivery instruction, in which the user U2 who is the receiving deputy is set as the delivery destination, performs the delivery processing shown in FIG. 16, which will be described below. When the automatic delivery robot 300 arrives at the set delivery destination, the automatic delivery robot 300 transmits a destination arrival notification to the image forming apparatus 100. Next, the CPU 101a judges whether or not the user U1 who is the request source of the print delivery processing is present (a step S1120). In the step S1120, in the case that the presence confirmation notification has been received from the PC 201 of the user U1, the CPU 101a judges that the user U1 is present. On the other hand, in the step S1120, in the case that the presence confirmation notification has not been received from the PC 201 of the user U1, the CPU 101a judges that the user U1 is not present.

In the case of being judged in the step S1120 that the user U1 is present, the CPU 101a judges whether or not the reception NG flag is ON (a step S1121). In the case of being judged in the step S1121 that the reception NG flag is not ON, the CPU 101a judges that the user U1 who is absent has returned to his/her seat, and changes the delivery destination from the receiving deputy to the user U1 (a step S1122). The CPU 101a transmits a delivery instruction, in which the delivery destination is changed to the user U1, to the automatic delivery robot 300. As described above, in the preferred embodiment of the present invention, in the case that the presence of the user U1 has been confirmed before the printed matter is delivered to the receiving deputy after the receiving deputy is set as the delivery destination, the delivery destination is changed from the receiving deputy to the user U1. By controlling in this way, it is possible to deliver the printed matter to the user U1 who is the request source of the print delivery processing as much as possible.

In the case of being judged in the step S1121 that the reception NG flag is ON, or in the case of being judged in the step S1120 that the user U1 is not present, the CPU 101a waits until it receives the destination arrival notification from the automatic delivery robot 300. When the CPU 101a receives the destination arrival notification from the automatic delivery robot 300 (YES in a step S1123), the CPU 101a performs the reception propriety confirmation processing for the receiving deputy (a step S1124). Specifically, the CPU 101a transmits the above-described instruction that displays the reception propriety confirmation screen to the PC 202. The PC 202 that has received the above-described instruction that displays the reception propriety confirmation screen causes the display unit of the PC 202 to display the reception propriety confirmation screen PD2. When the user U2 selects the button PB2 of the reception propriety confirmation screen PD2, the PC 202 transmits a receivable notification, which indicates that the user U2 is able to receive the printed matter, to the image forming apparatus 100. Moreover, the reception propriety confirmation processing for the receiving deputy in the step S1124 is performed by utilizing the polling performed by the printer driver of the PC 202.

Next, the CPU 101a judges whether or not the receivable notification has been received from the PC 202 (a step S1125). In the case of being judged in the step S1125 that the receivable notification has been received from the PC 202, the delivery control processing proceeds to a step S1128 described below. In the case of being judged in the step S1125 that the receivable notification has not been received from the PC 202, the CPU 101a waits for a certain period of time determined in advance (a step S1126). Next, the CPU 101a judges whether or not the receivable notification has been received from the PC 202 (a step S1127). In the case of being judged in the step S1127 that the receivable notification has been received from the PC 202, the delivery control processing proceeds to the step S1128.

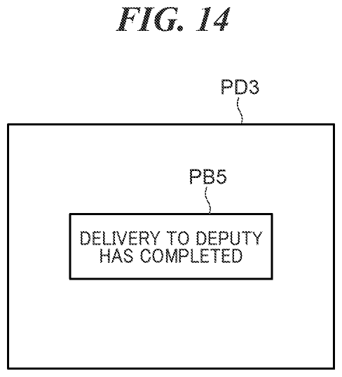

In the step S1128, the CPU 101a issues an instruction, which delivers the printed matter to the user U2 who is the receiving deputy, with respect to the automatic delivery robot 300. Next, the CPU 101a waits until it receives a delivery completion notification from the automatic delivery robot 300. When the CPU 101a receives the delivery completion notification from the automatic delivery robot 300 (YES in a step S1129), the CPU 101a transmits an instruction that displays a deputy reception completion screen to the PC 201 of the user U1 (a step S1130). The PC 201 that has received the instruction that displays the deputy reception completion screen causes the display unit of the PC 201 to display, for example, a deputy reception completion screen PD3 shown in FIG. 14. The deputy reception completion screen PD3 is a pop-up screen. A notification PBS, which indicates that the receiving deputy has received the printed matter, is displayed on the deputy reception completion screen PD3. It should be noted that it is preferable to display information, which is able to identify the receiving deputy such as the name of the receiving deputy or the like, on the deputy reception completion screen PD3. As a result, it is possible to inform the user U1 who is the request source of the print delivery processing that the receiving deputy has received the printed matter. Thereafter, the delivery control processing ends.

In the case of being judged in the step S1127 that the receivable notification has not been received from the PC 202, the CPU 101a transmits a delivery instruction, in which the delivery destination is set to the storage box 400, to the automatic delivery robot 300 (a step S1131). The delivery instruction, in which the delivery destination is set to the storage box 400, includes delivery destination information such as information indicating the storage box 400 set as the delivery destination, information indicating the position of the storage box 400, etc. In addition, the delivery instruction, in which the delivery destination is set to the storage box 400, also includes the authentication code required when receiving the printed matter. In addition, also in the case of being judged in the step S1118 that the presence of the user U2 within the certain period of time has not been confirmed, the delivery control processing proceeds to the step S1131. Thus, in the preferred embodiment of the present invention, in the case that neither the user U1 nor the user U2 is confirmed to be present, the storage box 400 is set as the delivery destination. As a result, it is possible to store the printed matter in the storage box 400 while preventing a delay in a processing for delivering other printed matter due to the absence of both the request source of the print delivery processing and the receiving deputy.

In addition, also in the case of being judged in the step S1114 that the reception NG flag is ON, the delivery control processing proceeds to the step S1131. As described above, in the preferred embodiment of the present invention, in the case that the delivery of the printed matter has not been completed even though the automatic delivery robot 300 has delivered the printed matter to the seat of the user U1 who is the request source of the print delivery processing, the storage box 400 is set as the delivery destination. As a result, it is possible to prevent the automatic delivery robot 300, which could not complete the delivery of the printed matter, from continuing to hold the printed matter indefinitely and being unable to accept the processing for delivering the other printed matter during continuing to hold the printed matter.

Next, the CPU 101a waits until it receives a storage completion notification, which indicates that the storage of the printed matter in the storage unit 404 of the storage box 400 has been completed, from the automatic delivery robot 300. When the CPU 101a receives the storage completion notification from the automatic delivery robot 300 (YES in a step S1132), the delivery control processing proceeds to a step S1133. In the step S1133, the CPU 101a controls the WLAN-I/F unit 108 to notify the storage box 400 of an authentication code, which becomes an unlocking code, and instruct the storage box 400 to lock the storage unit 404. Thus, in the preferred embodiment of the present invention, whether or not to lock the storage unit 404 is controlled based on the instruction from the image forming apparatus 100.

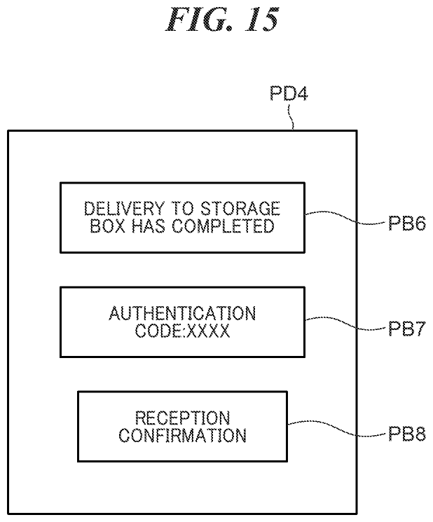

Next, the CPU 101a transmits an instruction that displays a storage completion screen to the PC 201 of the user U1 (a step S1134). The PC 201 that has received the instruction that displays the storage completion screen causes the display unit of the PC 201 to display, for example, a storage completion screen PD4 shown in FIG. 15. The storage completion screen PD4 is also a pop-up screen. A notification PB6, which indicates that the storage of the printed matter in the storage box 400 has been completed, and an authentication code PB7, which becomes the unlocking code are displayed on the storage completion screen PD4. Furthermore, a reception confirmation button PB8, which is selected when the user U1 receives the printed matter from the storage box 400, is displayed on the storage completion screen PD4. When the user U1 selects the reception confirmation button PB8, the PC 201 transmits a reception completion notification, which indicates that the user U1 has received the printed matter, to the image forming apparatus 100. The CPU 101a waits until it receives the reception completion notification from the PC 201. When the CPU 101a receives the reception completion notification from the PC 201 (a step S1135), the delivery control processing ends.

FIG. 16 is a flow chart that shows a procedure of the delivery processing executed by the automatic delivery robot 300 shown in FIG. 1. The delivery processing shown in FIG. 16 is realized by the CPU 303a reading a program stored in the ROM 303c into the RAM 303b and executing it.

As shown in FIG. 16, first, the CPU 303a waits until the printed matter is delivered from the image forming apparatus 100. When the printed matter is delivered from the image forming apparatus 100 (YES in a step S1601), the CPU 303a stores the printed matter in the collecting unit 306 and then locks the collecting unit 306 so that the printed matter cannot be taken out (a step S1602). It should be noted that an unlocking code of the collecting unit 306 is the authentication code notified from the image forming apparatus 100 in the step S1102. Next, the CPU 303a receives the delivery instruction from the image forming apparatus 100 via the WLAN-I/F unit 308 (a step S1603).

Next, the CPU 303a performs a control so that the automatic delivery robot 300 starts moving to the delivery destination, which is set in the delivery instruction obtained in the step S1603 (a step S1604). When the automatic delivery robot 300 arrives at the delivery destination, which is a destination (YES in a step S1605), the CPU 303a transmits the destination arrival notification, which indicates that the automatic delivery robot 300 has arrived at the destination, to the image forming apparatus 100 via the WLAN-I/F unit 308 (a step S1606). Next, the CPU 303a judges whether or not the delivery destination is the storage box 400 (a step S1607).

In the case of being judged in the step S1607 that the delivery destination is not the storage box 400, the CPU 303a judges whether or not an operation of the operation input unit 304b has been detected within a certain period of time after the automatic delivery robot 300 arrives at the destination (a step S1608). In the case of being judged in the step S1608 that the operation of the operation input unit 304b has not been detected within the certain period of time after the automatic delivery robot 300 arrives at the destination, the CPU 303a notifies the image forming apparatus 100 that the receiver does not show up even after the certain period of time has elapsed (a step S1609). Thereafter, the delivery processing returns to the step S1603.

In the case of being judged in the step S1608 that the operation of the operation input unit 304b has been detected within the certain period of time after the automatic delivery robot 300 arrives at the destination, the CPU 303a waits until an unlocking code, which matches the authentication code included in the delivery instruction received in the step S1603, is inputted into the operation input unit 304b. When the unlocking code, which matches the authentication code included in the delivery instruction received in the step S1603, is inputted into the operation input unit 304b (YES in a step S1610), the CPU 303a unlocks the collecting unit 306 so that the printed matter can be taken out (a step S1611). Next, the CPU 303a transmits the delivery completion notification to the image forming apparatus 100 (a step S1612). Next, the CPU 303a performs a control so that the automatic delivery robot 300 returns to the location of the image forming apparatus 100 (a step S1613), and ends the delivery processing.

In the case of being judged in the step S1607 that the delivery destination is the storage box 400, the CPU 303a uses the discharging unit 307 to store the printed matter in the storage box 400 (a step S1614), and ends the delivery processing.

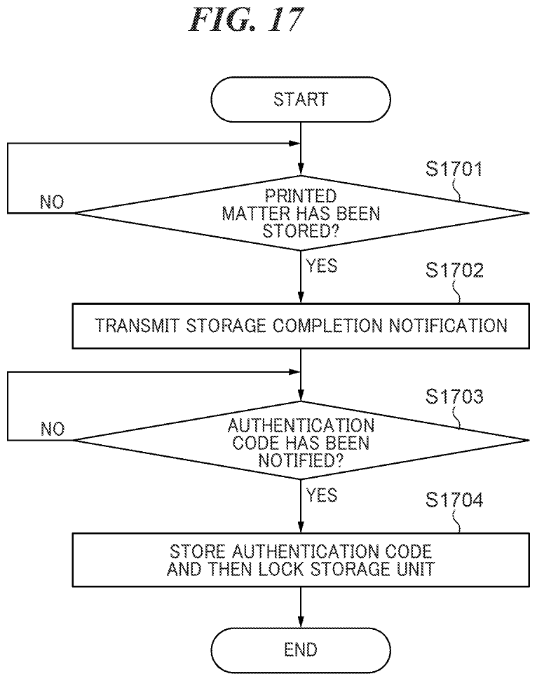

FIG. 17 is a flow chart that shows a procedure of a printed matter storage processing in the storage box 400 shown in FIG. 1. The printed matter storage processing shown in FIG. 17 is realized by the CPU 401a reading a program stored in the ROM 401c into the RAM 401b and executing it. The printed matter storage processing shown in FIG. 17 is executed when the printed matter is received from the automatic delivery robot 300.

As shown in FIG. 17, the CPU 401a uses the sensor unit 405 to judge whether or not the printed matter has been stored in the storage unit 404 (a step S1701). In the case of being judged in the step S1701 that the printed matter has not been stored in the storage unit 404, the printed matter storage processing remains at the step S1701. In the case of being judged in the step S1701 that the printed matter has been stored in the storage unit 404, the printed matter storage processing proceeds to a step S1702. In the step S1702, the CPU 401a transmits the storage completion notification to the image forming apparatus 100 via the WLAN-I/F unit 403. Next, the CPU 401a waits until the authentication code is notified from the image forming apparatus 100. When the authentication code is notified from the image forming apparatus 100 (YES in a step S1703), the CPU 401a stores the authentication code in the RAM 401b as the unlocking code, and locks the storage unit 404 based on the authentication code (a step S1704). Thereafter, the printed matter storage processing ends.

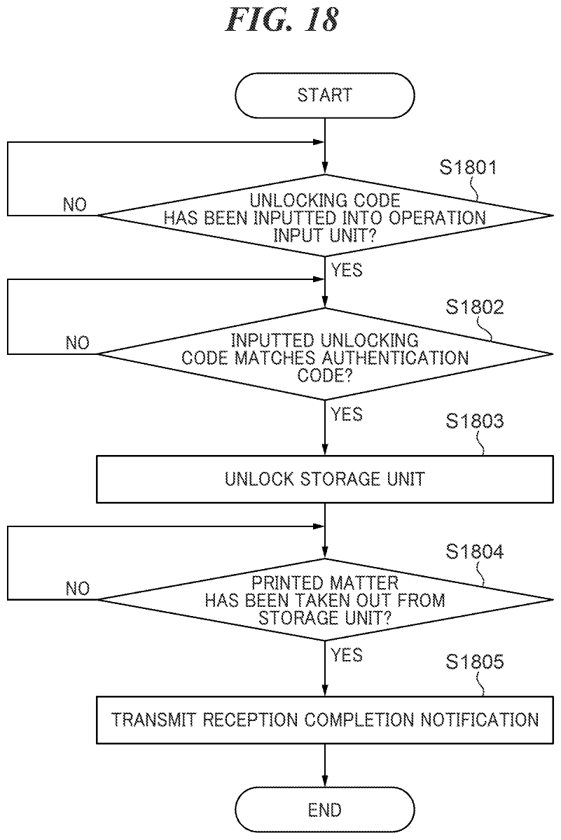

FIG. 18 is a flow chart that shows a procedure of an unlocking control processing in the storage box 400 shown in FIG. 1. The unlocking control processing shown in FIG. 18 is realized by the CPU 401a reading a program stored in the ROM 401c into the RAM 401b and executing it. In the unlocking control processing shown in FIG. 18, it is assumed that the printed matter storage processing described above has been executed and the printed matter has been stored in the storage unit 404.

As shown in FIG. 18, the CPU 401a judges whether or not the unlocking code has been inputted into the operation input unit 402b (a step S1801). In the case of being judged in the step S1801 that the unlocking code has not been inputted into the operation input unit 402b, the unlocking control processing remains at the step S1801. In the case of being judged in the step S1801 that the unlocking code has been inputted into the operation input unit 402b, the unlocking control processing proceeds to a step S1802. In the step S1802, the CPU 401a judges whether or not the inputted unlocking code matches the authentication code stored in the RAM 401b (the step S1802). In the case of being judged in the step S1802 that the inputted unlocking code does not match the authentication code stored in the RAM 401b, the unlocking control processing remains at the step S1802. In the case of being judged in the step S1802 that the inputted unlocking code matches the authentication code stored in the RAM 401b, the unlocking control processing proceeds to a step S1803.

In the step S1803, the CPU 401a unlocks the storage unit 404. As a result, the user who has inputted the unlocking code into the operation input unit 402b is able to take out the printed matter from the storage unit 404. Next, the CPU 401a uses the sensor unit 405 to judge whether or not the printed matter has been taken out from the storage unit 404 (a step S1804). In the case of being judged in the step S1804 that the printed matter has not been taken out from the storage unit 404, the unlocking control processing remains at the step S1804. In the case of being judged in the step S1804 that the printed matter has been taken out from the storage unit 404, the unlocking control processing proceeds to a step S1805. In the step S1805, the CPU 401a transmits the reception completion notification to the image forming apparatus 100 via the WLAN-I/F unit 403 (the step S1805), and ends the unlocking control processing.

According to the above-described preferred embodiment of the present invention, the presence confirmation processing for the user U1 who is the request source of the print delivery processing is executed. In the case that the presence of the user U1 has been confirmed, the delivery instruction, in which the user U1 is set as the delivery destination, is transmitted to the automatic delivery robot 300. In the case that the presence of the user U1 has not been confirmed, the delivery instruction, in which the receiving deputy who is the deputy for the user U1 is set as the delivery destination, is transmitted to the automatic delivery robot 300. That is, in the preferred embodiment of the present invention, the presence status of the user U1 is confirmed before the delivery instruction is transmitted to the automatic delivery robot 300, and the delivery instruction, in which the user U1 whose presence is not confirmed is set as the delivery destination, will never be transmitted to the automatic delivery robot 300. As a result, it is possible to prevent the automatic delivery robot 300 from making an unnecessary movement to the seat of the user U1 whose presence is not confirmed, and therefore, it is possible to prevent the delay in the processing for delivering the other printed matter due to the absence of the user U1.

Although the present invention has been described by using the above-described preferred embodiment, the present invention is not limited to the above-described preferred embodiment. For example, instead of the e-mail in the step S1116, a pop-up screen may be used to notify the receiving deputy of the authentication code.

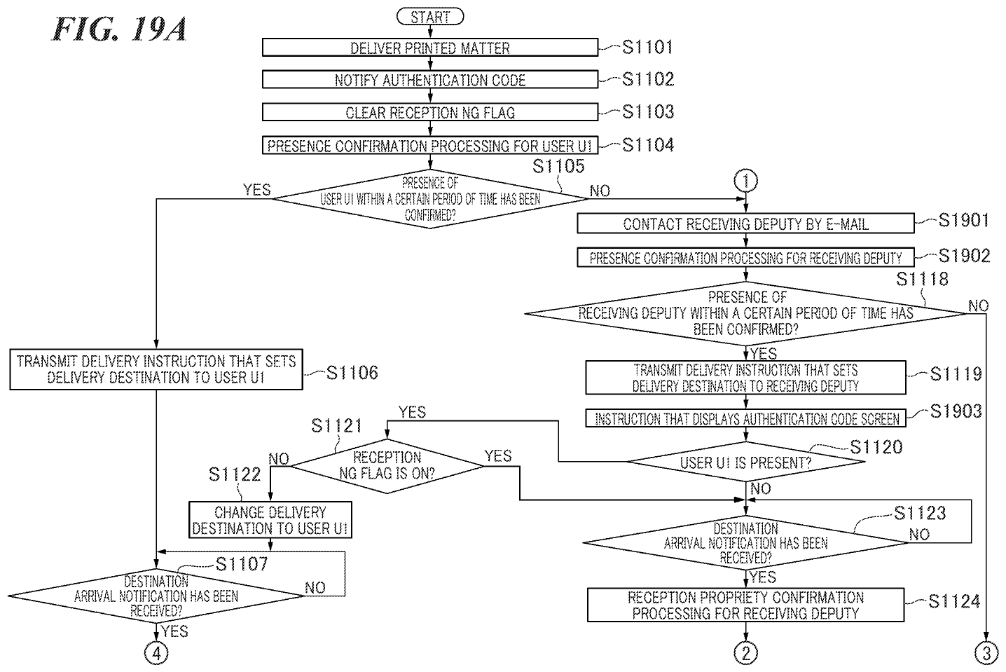

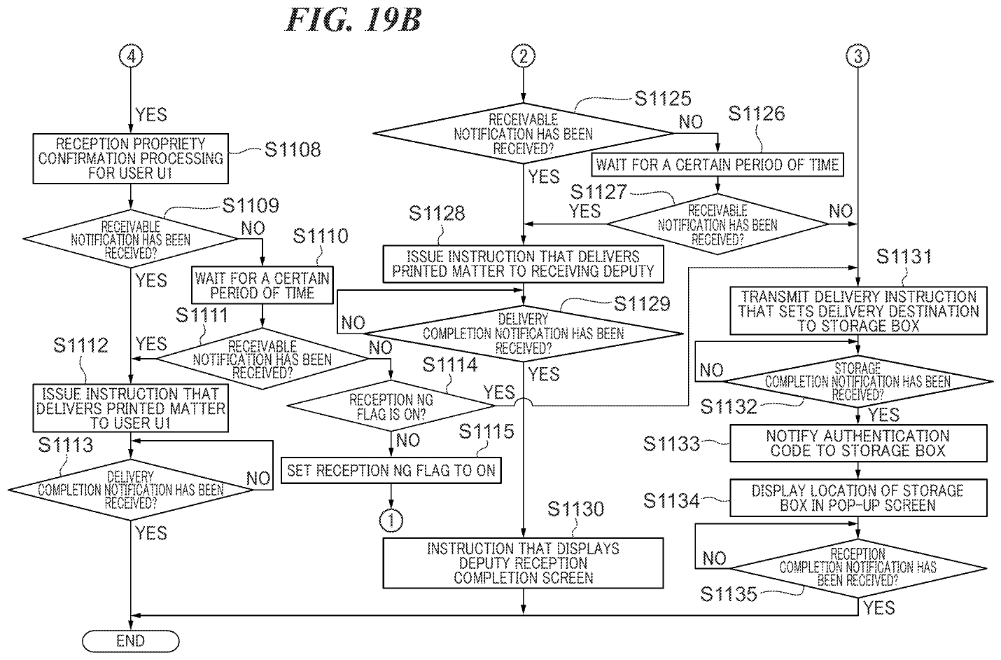

FIGS. 19A and 19B are flow charts that show another procedure of the delivery control processing executed in the image forming apparatus 100 shown in FIG. 1. It should be noted that the delivery control processing shown in FIGS. 19A and 19B is a processing similar to the delivery control processing shown in FIGS. 11A and 11B. Here, especially the contents different from the delivery 25 control processing shown in FIGS. 11A and 11B will be described. As with the delivery control processing shown in FIGS. 11A and 11B, the delivery control processing shown in FIGS. 19A and 19B is also realized by the CPU 101a reading the program 109a stored in the storage device 109 into the memory 101b and executing it. In addition, as with the delivery control processing shown in FIGS. 11A and 11B, the delivery control processing shown in FIGS. 19A and 19B is executed when the production of all printed matters related to the received print data is completed. Also in FIGS. 19A and 19B, as an example, it is assumed that the delivery control processing is a processing based on a request received from the user U1.

As shown in FIGS. 19A and 19B, first, the CPU 101a performs the processes of the steps S1101 to S1105 described above. In the case of being judged in the step S1105 that the presence of the user U1 within the certain period of time has been confirmed, the delivery control processing proceeds to the step S1106. In the case of being judged in the step S1105 that the presence of the user U1 within the certain period of time has not been confirmed, the CPU 101a contacts the receiving deputy designated by the user U1, for example, the user U2 by e-mail, that is, the CPU 101a sends an e-mail to the PC of the receiving deputy designated by the user U1, for example, the PC 202 of the user U2 (a step S1901). The e-mail includes a notification indicating that the user U2 has been designated as the receiving deputy of the printed matter, and does not include the authentication code required when receiving the printed matter. When the user U2 clicks link information described in the e-mail, the printer driver of the PC 202 is activated, and a communication between the printer driver of the PC 202 and the image forming apparatus 100 performed by the polling is started.

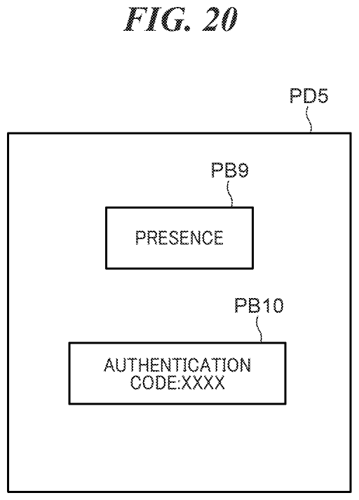

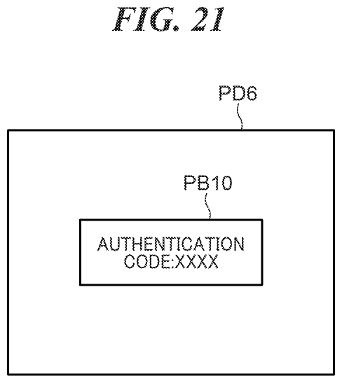

Next, the CPU 101a performs the presence confirmation processing for the user U2 who is the receiving deputy (a step S1902). Specifically, the CPU 101a transmits an instruction that displays a presence confirmation screen to the PC 202 of the user U2. The PC 202 that has received the instruction that displays the presence confirmation screen causes the display unit of the PC 202 to display, for example, a presence confirmation screen PD5 shown in FIG. 20. The presence confirmation screen PD5 is a pop-up screen. A presence button PB9 is displayed on the presence confirmation screen PD5 so as to be blinking. In addition, an authentication code PB10, which is required when receiving the printed matter, is displayed on the presence confirmation screen PD5. When the user U2 selects the presence button PB9, the PC 202 transmits a presence confirmation notification, which indicates that the user U2 is present, to the image forming apparatus 100. Next, the delivery control processing proceeds to the step S1118 described above. In the case of being judged in the step S1118 that the presence of the user U2 within the certain period of time has not been confirmed, the delivery control processing proceeds to the step S1131 described above. In the case of being judged in the step S1118 that the presence of the user U2 within the certain period of time has been confirmed, the delivery control processing proceeds to the step S1119 described above. Next, the CPU 101a transmits an instruction that displays an authentication code screen to the PC 202 of the user U2 (a step S1903). The PC 202 that has received the instruction that displays the authentication code screen causes the display unit of the PC 202 to display, for example, an authentication code screen PD6 shown in FIG. 21. The authentication code screen PD6 is a pop-up screen. The authentication code PB10, which is required when receiving the printed matter, is displayed on the authentication code screen PD6. Thereafter, the delivery control processing proceeds to the step S1120 described above.

In this manner, even in the configuration in which the notification of the authentication code to the receiving deputy is performed on the pop-up screen, it is possible to obtain the same effects as those of the above-described preferred embodiment.

In addition, in the above-described preferred embodiment, the image forming apparatus 100 may notify the authentication code to a mobile terminal of the receiving deputy. In this case, the image forming apparatus 100 may notify the authentication code by e-mail to a pre-registered e-mail address of the mobile terminal of the receiving deputy, or may notify the authentication code via an application installed on the mobile terminal of the receiving deputy.

In the above-described preferred embodiment, the number of the receiving deputies is not limited to one, but may be plural, and the receiving deputies may be set for groups such as departments. As a result, it is possible to prevent the delay in the processing for delivering the other printed matter due to the absence of the request source of the print delivery processing and some of the receiving deputies.

In addition, in the above-described preferred embodiment, in the case that a plurality of the receiving deputies are set, the presence confirmation processing may be executed in order from the receiving deputy with the highest priority designated by the request source of the print delivery processing. As a result, it is possible to more precisely reflect the intention of the request source of the print delivery processing in the setting of the delivery destination when the request source of the print delivery processing is absent.

In addition, in the above-described preferred embodiment, in the case that a plurality of the receiving deputies are set, the presence confirmation processing may be executed in order from the receiving deputy whose seat is closest to the request source of the print delivery processing. As a result, when the request source of the print delivery processing is absent, it is possible to deliver the printed matter to the receiving deputy whose seat is close to the request source of the print delivery processing.

In addition, in the above-described preferred embodiment, a configuration, in which the number of the storage boxes 400 is not limited to one and a plurality of the storage boxes 400 are disposed, may be employed. In such a configuration, the printed matter is stored in the storage box 400 in which the storage unit 404 is empty among the plurality of the storage boxes 400, and the request source of the print delivery processing is notified to which storage box 400 the printed matter has been delivered. As a result, in the case that the request source of the print delivery processing is absent and the storage units 404 of some of the storage boxes 400 are full, it is possible to store the printed matter in other storage boxes 400.

In addition, in the above-described preferred embodiment, in the case that the request for the print delivery processing is made without setting the receiving deputy on the setting screen 900 shown in FIG. 10, when the request source of the print delivery processing is absent, the storage box 400 may be set as the delivery destination. As a result, it is possible to store the printed matter in the storage box 400 while preventing the delay in the processing for delivering the other printed matter due to the absence of the request source of the print delivery processing.

In addition, in the above-described preferred embodiment, in the case that both the request source of the print delivery processing and the receiving deputy are absent for a certain period of time or longer, the image forming apparatus 100 may cause the automatic delivery robot 300 to discard the printed matter, and may notify the request source of the print delivery processing that the printed matter has been discarded. As a result, it is possible to prevent the delay in the processing for delivering the other printed matter due to the absence of the request source of the print delivery processing and the receiving deputy.

In the above-described preferred embodiment, although the configuration in which the authentication code is used when receiving the printed matter from the automatic delivery robot 300 and when receiving the printed matter from the storage box 400 has been described, the present invention is not limited to this configuration. For example, in a configuration of using personal authentication information read from an integrated circuit (IC) card or the like when logging into the image forming apparatus 100, the printed matter may be received from the automatic delivery robot 300 by using the personal authentication information and the printed matter may be received from the storage box 400 by using the personal authentication information. In such a configuration, the automatic delivery robot 300 may perform an authentication processing based on the personal authentication information, and the storage box 400 may perform an authentication processing based on the personal authentication information.

Alternatively, such a configuration may be may be employed, that is, the image forming apparatus 100 performs an authentication processing based on the personal authentication information, and in the case that the authentication is successful, the image forming apparatus 100 notifies the automatic delivery robot 300 and the storage box 400 that the delivery of the printed matter is permitted, and whether or not the automatic delivery robot 300 performs unlocking and whether or not the storage box 400 performs unlocking are controlled based on this notification.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-078915, filed on May 12, 2022, which is hereby incorporated by reference herein in its entirety.

What is claimed is:

1. An image forming apparatus that performs a print processing to produce a printed matter in accordance with an instruction received from an information processing apparatus operated by a user, and that transmits a delivery instruction, in which a delivery destination of the printed matter is set, to a printed matter delivery apparatus, the image forming apparatus comprising:
a controller configured or programmed to
execute a presence confirmation processing for confirming a presence status of the user, and
in a case that the presence of the user has been confirmed, transmit a delivery instruction, in which the user is set as the delivery destination, to the printed matter delivery apparatus, and in a case that the presence of the user has not been confirmed, transmit a delivery instruction, in which a deputy for the user is set as the delivery destination, to the printed matter delivery apparatus.

2. The image forming apparatus according to claim 1,
wherein the deputy for the user is a receiving deputy designated by the user.

3. The image forming apparatus according to claim 2,
wherein, in the case that the presence of the user has not been confirmed, the controller is configured or programmed to execute a presence confirmation processing for the receiving deputy.

4. The image forming apparatus according to claim 2,
wherein, in a case that the presence of the user has been confirmed before the printed matter is delivered to the receiving deputy after the receiving deputy is set as the delivery destination, the controller is configured or programmed to transmit a delivery instruction, in which the delivery destination is changed to the user, to the printed matter delivery apparatus.

5. The image forming apparatus according to claim 2,
wherein a plurality of receiving deputies are designated as the deputy for the user.

6. The image forming apparatus according to claim 5,
wherein, in a case that the plurality of receiving deputies are designated as the deputy for the user, the controller is configured or programmed to execute a presence confirmation processing in order from the receiving deputy with the highest priority designated by the user.

7. The image forming apparatus according to claim 5,
wherein, in a case that the plurality of receiving deputies are designated as the deputy for the user, the controller is configured or programmed to execute a presence confirmation processing in order from the receiving deputy whose seat is closest to the user.

8. The image forming apparatus according to claim 2,
wherein, in a case that neither the user nor the receiving deputy is confirmed to be present, the controller is configured or programmed to transmit an instruction that discards the printed matter to the printed matter delivery apparatus.

9. The image forming apparatus according to claim 1,
wherein, in a case that a delivery destination other than the user is set as the delivery destination, the controller is configured or programmed to notify the user of information that indicates the delivery destination.

10. The image forming apparatus according to claim 2,
wherein, in a case that neither the user nor the receiving deputy is confirmed to be present, a storage apparatus, which comprises a storage unit having a locking function, is set as the delivery destination.

11. The image forming apparatus according to claim 1,
wherein the controller is configured or programmed to
retain history information indicating that delivery of the printed matter has not been completed even though the printed matter delivery apparatus has delivered the printed matter to a seat of the user, and
in a case that the delivery of the printed matter has not been completed even though the printed matter delivery apparatus has delivered the printed matter to the seat of the user, transmit a delivery instruction, in which a storage apparatus comprising a storage unit having a locking function is set as the delivery destination, to the printed matter delivery apparatus.

12. The image forming apparatus according to claim 1,
wherein the deputy for the user is a storage apparatus, which comprises a storage unit having a locking function.

13. The image forming apparatus according to claim 10,
wherein, in a case that a delivery destination other than the user is set as the delivery destination, the controller is configured or programmed to transmit code information used when receiving the printed matter to the delivery destination, and
the storage apparatus uses the code information to unlock the storage unit.

14. The image forming apparatus according to claim 11,
wherein, in a case that a delivery destination other than the user is set as the delivery destination, the controller is configured or programmed to transmit code information used when receiving the printed matter to the delivery destination, and
the storage apparatus uses the code information to unlock the storage unit.

15. The image forming apparatus according to claim 12,
wherein, in a case that a delivery destination other than the user is set as the delivery destination, the controller is configured or programmed to transmit code information used when receiving the printed matter to the delivery destination, and
the storage apparatus uses the code information to unlock the storage unit.

16. A control method for an image forming apparatus that performs a print processing to produce a printed matter in accordance with an instruction received from an information processing apparatus operated by a user, and that transmits a delivery instruction, in which a delivery destination of the printed matter is set, to a printed matter delivery apparatus,
the control method comprising:
executing a presence confirmation processing for confirming a presence status of the user; and
in a case that the presence of the user has been confirmed, transmitting a delivery instruction, in which the user is set as the delivery destination, to the printed matter delivery apparatus, and in a case that the presence of the user has not been confirmed, transmitting a delivery instruction, in which a deputy for the user is set as the delivery destination, to the printed matter delivery apparatus.

17. A non-transitory computer-readable storage medium storing a program for causing a computer to execute a control method for an image forming apparatus that performs a print processing to produce a printed matter in accordance with an instruction received from an information processing apparatus operated by a user, and that transmits a delivery instruction, in which a delivery destination of the printed matter is set, to a printed matter delivery apparatus,
the control method comprising:
executing a presence confirmation processing for confirming a presence status of the user; and
in a case that the presence of the user has been confirmed, transmitting a delivery instruction, in which the user is set as the delivery destination, to the printed matter delivery apparatus, and in a case that the presence of the user has not been confirmed, transmitting a delivery instruction, in which a deputy for the user is set as the delivery destination, to the printed matter delivery apparatus.

18. A printed matter delivery system that comprises an image forming apparatus and a printed matter delivery apparatus, comprising:
an accepting unit configured or programmed to accept an instruction for executing a print delivery processing that causes the image forming apparatus to produce a printed matter and causes printed matter delivery apparatus to deliver the printed matter;
a processing unit configured or programmed to execute a presence confirmation processing for confirming a presence status of a user who has issued the instruction for executing the print delivery processing;
a setting unit configured or programmed to set a deputy for the user who receives the printed matter instead of the user; and
a delivery destination setting unit configured or programmed to set the user to a delivery destination of the printed matter in a case that the presence of the user has been confirmed, and set the deputy for the user to the delivery destination in a case that the presence of the user has not been confirmed.
